(19) United States
(12) Patent Application Publication
(10) Pub. No.: US 2006/0080210 A1
(43) Pub. Date: Apr. 13, 2006

(54) System and network for obtaining competitive quotes on user-configured articles

(75) Inventors: Tamim Mourad, Los Angeles, CA (US); Corey E. Ostman, Stratham, NH (US); Francisco J. Gimenez, Beverly Hills, CA (US); Ronald A. LaPierre, La Verne, CA (US); Bryan A. Van Cleave, Huntington Beach, CA (US)

Correspondence Address: INTELLECTUAL PROPERTY LAW OFFICE OF JOEL VOELZKE, 400 CORPORATE POINTE, SUITE 300, CULVER CITY, CA, 90230, US

(73) Assignee: PriceGrabber.com, Inc.

(21) Appl. No.: 10/950,202

(22) Filed: Sep. 23, 2004

(51) Int. Cl. G06Q 40/00

(52) U.S. Cl. 705/37

(57) ABSTRACT

Configuration data received from a consumer regarding a configurable article such as an automobile in which the consumer is interested in purchasing is entered by the consumer and automatically forwarded to a number of participating dealers within the consumer's geographic area. The dealers can respond by quoting for an exact match of the article as configured or for a near exact match. The consumer is notified of the progress of quotes received as they are received. At the close of the quote period contact information is automatically exchanged between the consumer and the dealer who submitted the lowest exact match quote, and the dealer is charged a referral fee. The consumer can also request information regarding a selected non-exact match quote whereupon contact information is automatically exchanged between the consumer and the second dealer, and the second dealer is also charged a referral fee.

### CROSS-REFERENCE TO RELATED APPLICATIONS

None.

### BACKGROUND OF THE INVENTION

1. Field of the Invention

This invention relates to the field of a system and network for matching purchasers to vendors. More particularly, this invention relates to a system and network for obtaining competitive quotes for user-configured articles.

2. Description of Related Art

Traditional purchasing methods often required large expenditures of time for potential purchasers of an item to locate sellers of like items, and to negotiate for the purchase of those items. This was particularly true for the automobile consumer, for which transactions traditionally began with a consumer visiting a nearby dealer, discussing the type of car the purchaser wanted including make, model, color, and options, and haggling with the dealer to try to obtain the best possible price. Oftentimes the consumer felt pressured into buying a more expensive automobile than the consumer wanted. This time consuming process might be repeated as the consumer visited several dealers in an effort to obtain the best possible price for the automobile or automobiles in which the consumer was most interested. Many consumers find the face-to-face haggling process distasteful.

More recently, electronic communication methods have contributed significantly to the consumer's ability to negotiate with different dealers and to do so with less time invested and in a more comfortable environment than was previously possible. Some consumer advocates recommend sending a request for a quote (“RFQ”) to several dealers via facsimile, and then faxing the lowest quote to the other dealers in an effort to play the dealers off against each other and spur competition between the dealers.

Various Internet based car buying services have become more popular in recent years. These include sites as CarBargains.com, CarsDirect.com, Autobytel.com, InvoiceDealers.com, and Cars.com. Most of these services allow the user to configure his desired vehicle by specifying the year, make, model, color, and options that the user is interested in, and inputting the user's geographic area such as by providing a city or ZIP code. Some of these services state that they will put the consumer in touch with a nearby dealer who will send the consumer haggle-free pricing and delivery information. Some of the services then provide one or more offered prices for the desired vehicle by one or more dealers located within the user's area along with the contact information for the dealer or dealers. One of these services, CarBargains located at www.carbargains.com which currently resolves to http://www.checkbook.org/auto/carbarg.cfm, states that it will obtain and forward to the consumer at least five competitive bids from dealers in the consumer's area and forward those bids and the dealer contact information to the consumer. CarBargains currently charges the consumer $190 per use of the service.

### SUMMARY OF THE INVENTION

The present invention provides a unique system and method for competitive bidding for user-configured articles such as automobiles.

In one embodiment the system operates without charge to the consumer. The consumer visits the system web site using a browser program and, using a series of menus, configures the car he is interested in purchasing and optionally provides other parameters such as financing or trade-in information. The consumer enters in a geographic determiner such as a city and state or a zip code, and selects his dealer search range in a unit of measure such as miles or kilometers. The process generates a request for quote which may be sent to participating new automobile dealers within the specified distance range of the consumer. Alternatively, in order to keep the numbers of dealers invited to submit quotes to a reasonable number, the request for quote may be sent to only certain ones of the dealers within that geographic range. Those certain ones can be selected on the basis of their being the nearest dealers to the consumer, random selection, rotation, or some other selection process.

The user-provided configuration information is then sent to a number of automobile dealers within the consumer's geographic area such as by an email message. The dealers are advised that the quote period will be open for a specific period of time such as three days, and are invited to respond to the request for quotes. The dealers may then respond within the quote period by visiting a dealer quote management web page provided on the system and inputting a quote, or by responding via email with a quote. The quote may be either for the exact automobile as configured by the user, or may be for a car that differs slightly from the user-configured car. For example, the dealer may have in stock the car requested by the consumer except that the in stock car has a premium package not requested by the consumer. The ability to respond with a quote for a similar though not identical car is especially helpful for dealers trying to move their current inventory. The quotes can also be thought of as bids to sell, or selling bids.

During the quote open period dealers receive automatic notification such as by email if their quotes have been beaten by another dealer. All dealers can view the current quotes including the currently lowest quote, but cannot see the identities of the dealers who submitted those other quotes. The dealers can submit new quotes if they wish to do so in an effort to beat the currently lowest quote. Optionally, if a new lowest quote is received within a specified amount of time before the quote period closes, such as within the last hour, then the quote period can be extended by an additional period of time so that the dealer who had previously submitted the lowest quote will have the opportunity to beat the new lowest quote.

Dealers may submit quotes one by one in response to requests for quotes, or they may specify a standing quote or bid. The standing bid may effectively say, for example, “Always bid $1500 over invoice for a 2004 BMW Z4.” The standing bid may be for a specified amount over (or under) invoice (or MSRP). The standing bid may also effectively specify one or more cars that the dealer has in stock and wishes to sell, and thus create a standing order to place quotes for automobiles that are close enough to the particular car requested by the consumer that the dealer would like to submit a quote for supplying that car. The dealer may specify a time frame after which the standing bid will expire.

The consumer can also view the progress of the quotes. The service provides to the consumer a personalized quote progress page on the Internet showing the consumer the automobile as he has configured it, the manufacturer's suggested retail price, the dealer invoice price, the history of the quotes received, any applicable notes regarding whether and how the received quotes differ from the exact car as configured by the consumer, and the currently lowest quote. The service also sends to the consumer an automatic message such as via email or pager alert that a new lowest quote has been received. This process helps to personally involve the consumer in the progress of the quote process, and helps contribute to an auction-like environment thus generating interest, excitement, and commitment by the consumer.

At the end of the quote period the system sends to the consumer a message notifying the consumer of the lowest quote or bid, providing the contact information of the dealer who provided the lowest quote, and advising the consumer that someone from the lowest bidder's organization may be contacting him shortly. The system also automatically sends to the low bidder the consumer's contact information. The system also charges the low bidding dealer a referral fee. In this way consumers need not be charged for the service, and dealers receive high value leads in exchange for the fees they are charged.

Additionally, the consumer is provided with information regarding other quotes that were received including the distance at which the corresponding dealers are located. The system asks the consumer whether he would like to receive the contact information for the dealers submitting any of those other quotes. For example, the second lowest quote may be from a dealer who is located much closer to the consumer than the dealer who submitted the lowest quote, and therefore the second lowest quote from the closer dealer may be the more attractive quote to the consumer.

A unique feature of the present system is that dealers are encouraged to provide quotes for non-exact matches, thus increasing in some cases the pool of dealers who will respond to the request for quote and increasing the number of quotes received. This also gives the consumer the chance to receive quotes for cars with options that he may be interested in, but which otherwise would not be included within the quotes received. The consumer is given a variety of choices at the end of the process, all of which may be attractive to the consumer. In this way the consumer is presented with a range of options, all within the range the consumer's zone of interest and all of which are the result of a competitive bidding process.

If the consumer elects to receive the information regarding a second quote, then the consumer is given the contact information for the second dealer, the consumer is notified that the second dealer may be contacting him soon, and the consumer's contact information is sent to the second dealer. The second dealer is now also charged a referral fee. Thus, any selection by the consumer results in a relatively high value lead and a referral. Similarly, the consumer may select additional quotes for which to receive dealer contact information, resulting in additional exchanges of contact information and additional referral fees. If the user cannot be effectively contacted through the contact information he provided, the referral fee(s) may be cancelled or refunded at the dealers'request and upon confirmation that the user cannot be contacted.

Although particularly well suited to facilitating sales of user-configured motor vehicles using the Internet, the system can be used to sell other types of vehicles, fleets of vehicles, other types of user-configured articles, or even other non-configured articles or groups of products and using other types of networks.

In one aspect therefore, the invention includes a method of providing to a user at least one offered price for an article, the method comprising allowing the user to remotely enter configuration data to configure a desired article according to the user's preference, receiving the configuration data and forwarding the configuration data to a plurality of potential sellers of the article within the user's geographic area, receiving quotes or selling bids and bid information representing offered prices from the potential sellers, automatically notifying the user when a new lowest bid has been received, allowing the user to monitor progress of the bidding and view the bidding history on a personalized bid progress display page, selecting at least one of the bids and forwarding the selected bid to the user, sending mutual contact information to both the user and the potential seller making the lowest bid, and charging a fee to the potential seller whose bid was forwarded to the user, the potential seller defining the selected seller. Information regarding bids other than the lowest bid are also provided to the user, and if the user elects to receive additional information regarding one or more of the other bids mutual contact information is sent to the user and the next bidder, and the next bidder is also charged a referral fee. Bids may be standing bids that expire after a specified period of time. Potential sellers may be notified that their bids were beaten and invited to beat the currently lowest quote.

In another aspect, the invention is of a system which allows a user to request competitive quotes from a number of different sellers of a user-configured article, and in which the user is notified via an electronic means of the progress of the quotes received while the period for receiving quotes is still open. The notification can be via a personalized web page having current and historical information about the quotes received, and/or can be an automatic notification such as via an electronic mail message, an instant message, a pager message, a telephone message, or the like.

In yet another aspect, the invention is of a system for facilitating competitive quotes for selling a shopper-configured article, the system including means for allowing a shopper to specify a configuration of an article for possible purchase by the shopper, means for electronically gathering a number of quotes for the article from different vendors, means for automatically identifying one of the quotes received as being a preferred quote, means for forwarding the preferred quote to the shopper and specifically identifying the preferred quote as being preferred, and means for allowing the vendor who submitted the preferred quote to contact the shopper and be charged a fee for the referral. As used herein, the term “article” will be interpreted broadly to include services.

Exemplary embodiments of the invention will be further described below with reference to the drawings, in which like numbers refer to like parts.

### BRIEF DESCRIPTION OF THE DRAWINGS

According to one illustrative embodiment:

FIG. 1 is a simplified screen shot illustrating vehicle options shown to a user.

FIGS. 2A-2E are simplified screen shots illustrating the process by which the consumer configures his desired vehicle, including providing trade-in information and desired financing parameters.

FIG. 3 is a simplified screen shot illustrating a list of dealers presented to the consumer in response to the consumer's selection of geographic distance.

FIG. 4 is a simplified screen shot illustrating a summary presented to the user of the user's vehicle as configured.

FIG. 5A is a simplified screen shot illustrating the main quote management page provided to a participating dealer.

FIG. 5B is a simplified screen shot illustrating the page presented to a dealer for preparing a quote.

FIG. 6A is a simplified screen shot illustrating the main personalized quote progress page provided to the consumer to allow the consumer to monitor the progress of the quote process while the quote period is open.

FIG. 6B is a simplified screen shot illustrating some of the detail a consumer can view regarding a quote while the quote period is open.

FIG. 7 is a simplified screen shot illustrating the consumer's quote progress page after the quote period has closed.

FIG. 8 is a simplified screen shot illustrating the options presented to the user to select one of the quotes other than the lowest exact match quote and to receive contact information regarding that quote.

FIG. 9 is a simplified screen shot illustrating the screen at which a dealer enters a standing quote.

FIG. 10 is a generalized and simplified flow diagram illustrating the quote process.

### DETAILED DESCRIPTION OF THE PREFERRED EMBODIMENTS

The invention will be described below with reference to an illustrative embodiment in which a consumer seeks quotes for an automobile from new vehicle dealers. It is to be understood that the preferred embodiment is for illustration purposes only and does not limit the invention. Throughout the discussion, the terms “consumer,” “potential purchaser,” “user,” or “shopper” will be used to refer to the person who is seeking quotes for an article or articles. The term “price” will be used even though it may be understood that the price may be expressed either in absolute dollars or other monetary units, or relatively compared to manufacturer's suggested retail price (MSRP) or dealer invoice price. The terms “quote,” “selling bid,” “bid,” or “offering price” will refer to a quote by a potential seller of an article. The term “vendor,” “potential seller,” or “dealer” will refer to the potential seller who provides a quote to the system for the consumer's consideration. The term “person” will be used in its legal sense to refer to any individual, business entity, government entity, or the like.

In the illustrative embodiment the system is implemented across a global information network such as the Internet, and using protocols including the world wide web and hypertext transfer protocol (http). The information to be displayed is viewed by the consumer and by participating dealers using a program such as a commercially available browser program.

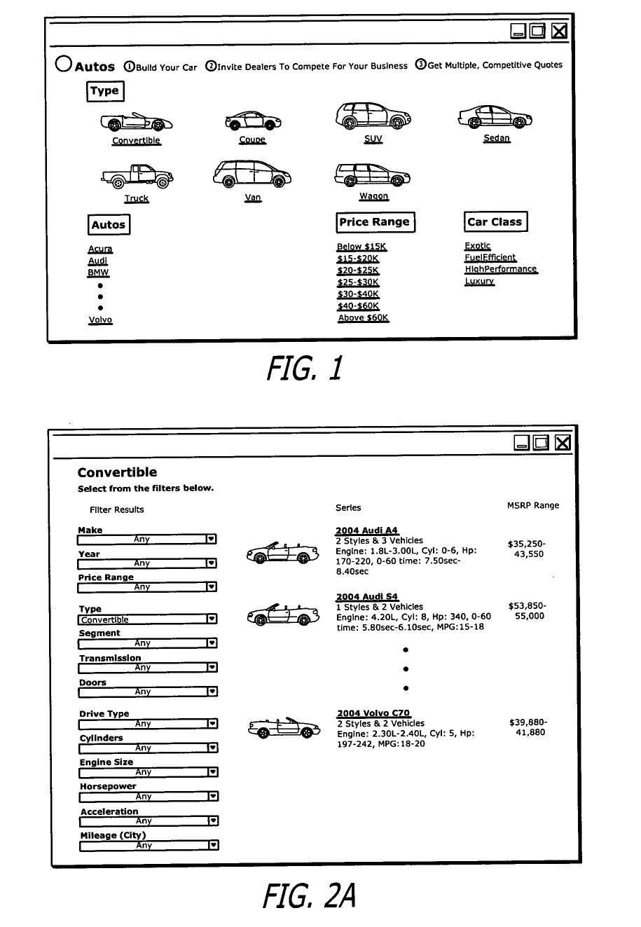

FIG. 1 is a simplified screen shot illustrating the screen by which the vehicle selection process begins in the illustrative embodiment. The consumer or other person can select year, make, and model of the vehicle, or may select style of vehicle such as convertible, pickup truck, coupe, van, minivan, wagon, SUV, sedan, etc. The user may also begin the selection process by selecting the type of vehicle such as luxury, economy, exotic, electric hybrid, etc.

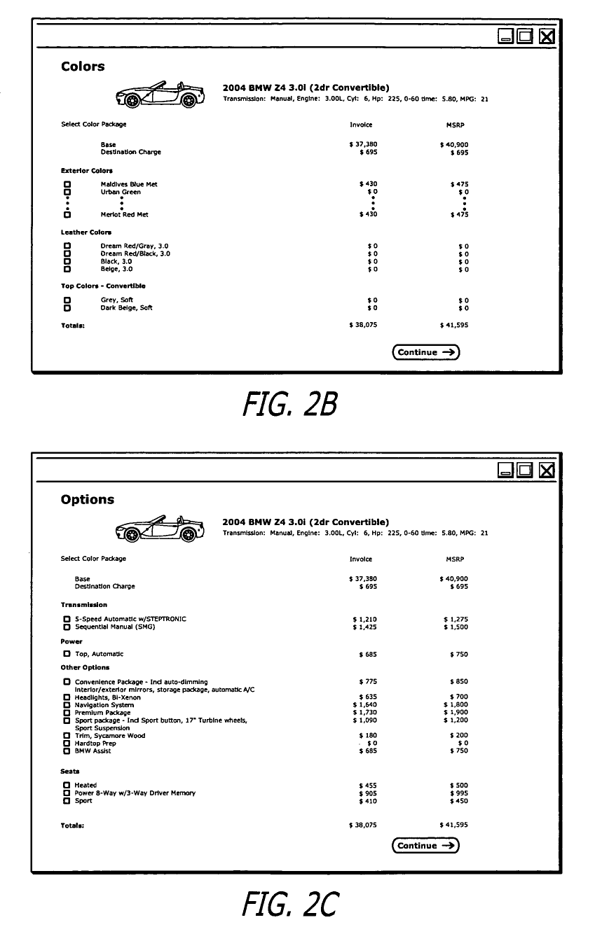

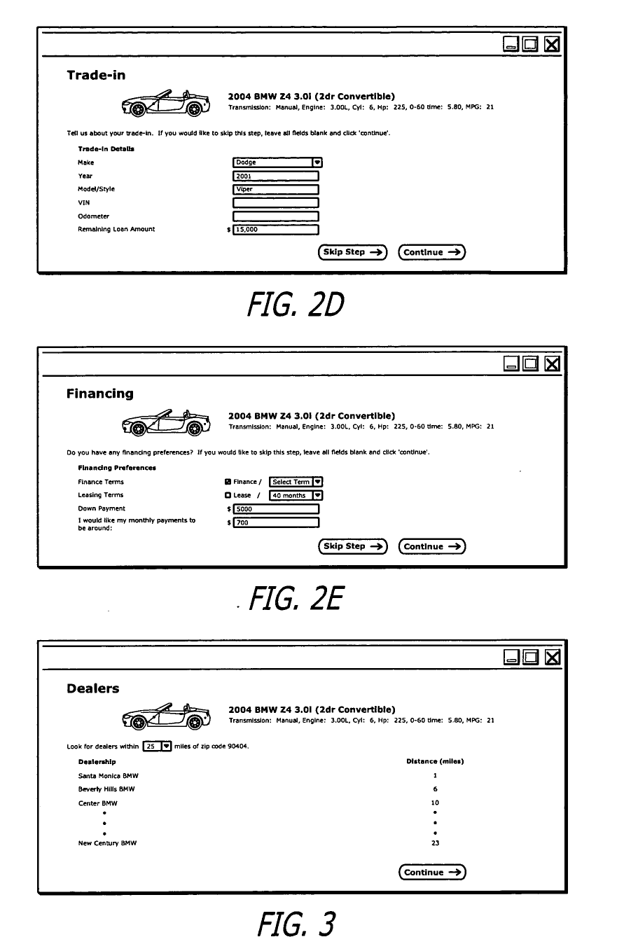

FIGS. 2A-2E are simplified screen shots illustrating the process by which the consumer configures his desired vehicle, including providing trade-in information and desired financing parameters. In FIG. 2A the consumer can narrow the range of automobiles displayed for his selection by selecting any combination of parameters such as year, make, model, price range, type, segment, transmission, number of doors, drive type, cylinders, engine size, horsepower, acceleration, and/or mileage. After the user has selected a particular year, make and model, in FIGS. 2B and 2C the user selects options available for that particular vehicle such as paint color, interior fabrics and colors, convertible top color, interior trim, transmission type, power seats, wheels, sports package, premium package, sound system, headlights, etc.

FIG. 2D illustrates the display page by which the user can enter his trade-in information. The user can enter year, make and model of his trade-in vehicle along with other pertinent information such as major options, mileage, and vehicle condition. FIG. 2E illustrates the display page by which the user can enter his financing parameters including purchase or lease, down payment, months financed, and/or monthly payment amount.

FIG. 3 is a simplified screen shot illustrating the page at which the user can enter his desired geographic distance range from his home city or zip code, and can view the list of dealers within the specified number of miles from the user. If the user wishes he can change the distance parameter, thus increasing or decreasing the number of dealers who may receive invitations to quote on the consumer-configured vehicle and increasing or decreasing the number of miles the consumer might have to travel in order to take advantage of the lowest quote offered or a different quote. Some sellers may not have a brick and mortar dealer location within the user's geographic area, but may be willing to deliver the vehicle to the consumer or near to the consumer. For purposes of this discussion, such sellers shall be considered to be within the user's geographic area.

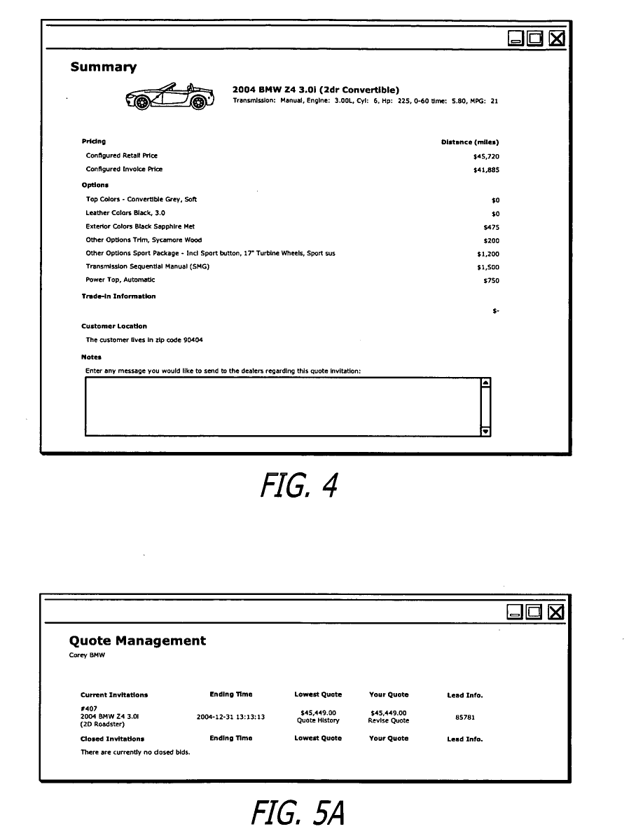

When the user has finished configuring his vehicle, he is presented with a summary of the vehicle as configured and the MSRP and/or dealer invoice price for the vehicle as configured. The user may add free text comments to his request for a quote such as required delivery information. FIG. 4 is a simplified screen shot illustrating the summary of the user-configured vehicle as presented to the consumer. The consumer is asked to confirm his vehicle as configured.

Once the consumer has configured his vehicle and submitted his request, an invitation to quote is automatically sent out to a number of dealers within the consumer's specified geographic region. The invitation to quote may be sent to all of the dealers within the geographic region. Alternatively, if the number of dealers within the geographic region is too large, in order to keep the number of invited dealers to a reasonable number the invitations to quote may be sent to a subset of the available dealers, with the subset chosen based on nearest distance to the consumer, randomly, or on a rotating basis to help ensure that no dealers receive preferential treatment. Alternatively, dealers who pay a periodic fee to participate in the program may receive preferential treatment over dealers who merely pay a referral fee but do not pay a participation fee. Referral fees will be discussed later. Still further, the dealers may be chosen based on nearness to the consumer, historical data relating to how often the dealers have quoted in the past, or some other criteria.

When a request for quote is submitted by a consumer, the dealers to whom the request for quote will be forwarded receive an automatic alert that they are being invited to respond to the request for quote. The alert may take the form of any one of known message types including email, pager alert, text messaging, instant message, telephone call, facsimile, Internet page posting, and others, or a combination of these message types. In the illustrative embodiment the alert is an email message.

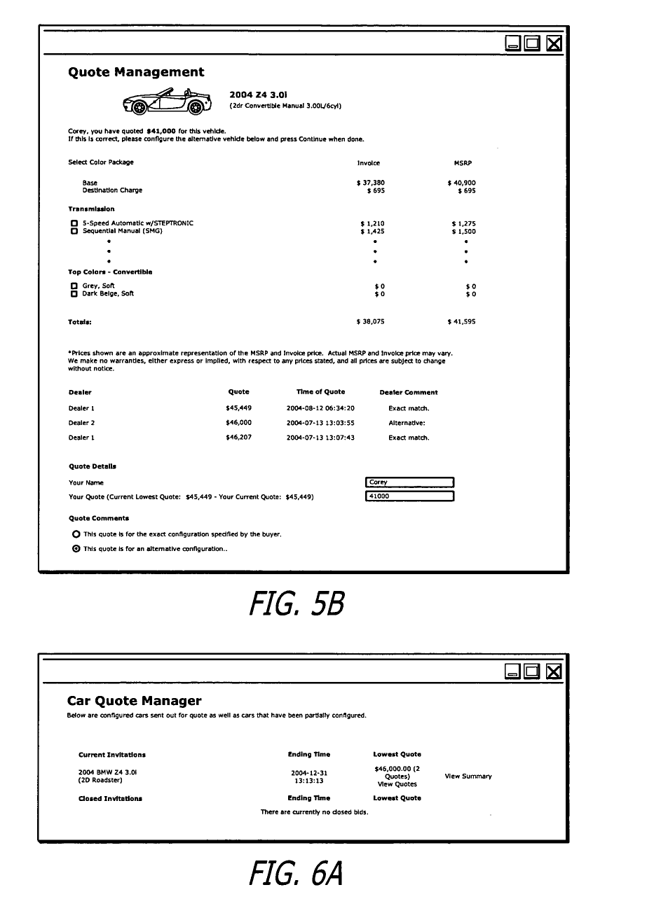

After receiving an invitation to quote, a participating dealer can visit a special quote management page established for that dealer on the world wide web. FIG. 5A is a simplified screen shot illustrating the main quote management page provided to a participating dealer. The quote management page assists the dealer in reviewing pending requests for quotes, viewing the status of quotes submitted by the dealer and his competitors, and in responding to requests. The dealer can view the current invitations to quote including the details of the configured vehicle for which a quote is requested, the quote ending time, the lowest quote received so far, and the quote(s) provided by the dealer. The dealer can also view closed invitations to bid. Although the dealer can see quotes from other dealers, in the preferred embodiment the dealer cannot see the identities of the other dealers who submitted those quotes. FIG. 5B is a simplified screen shot illustrating the page presented to a dealer when preparing a quote. The dealer has the option of either quoting to sell the vehicle exactly as configured by the user, or differently configuring a vehicle and responding with a quote for that near-match vehicle. A near-match vehicle is a vehicle that differs from the user-configured vehicle only slightly, such that a consumer might reasonably be expected to consider the near-match vehicle a potentially acceptable alternative. For example, the dealer may have a vehicle in stock of the same year, make, and model, but the vehicle in stock may differ slightly in color or other options from the user-configured vehicle. Depending on the other quotes submitted by other dealers, the vehicle in stock may therefore represent the most attractive vehicle to the consumer despite the differences from the vehicle as configured, particularly after considering the price, distance to the dealer, and other potentially salient considerations. The dealer can also provide free text comments to explain or otherwise accompany the quote, such as the fact that the vehicle is in stock and has a specified number of demonstration miles on it, or any other message.

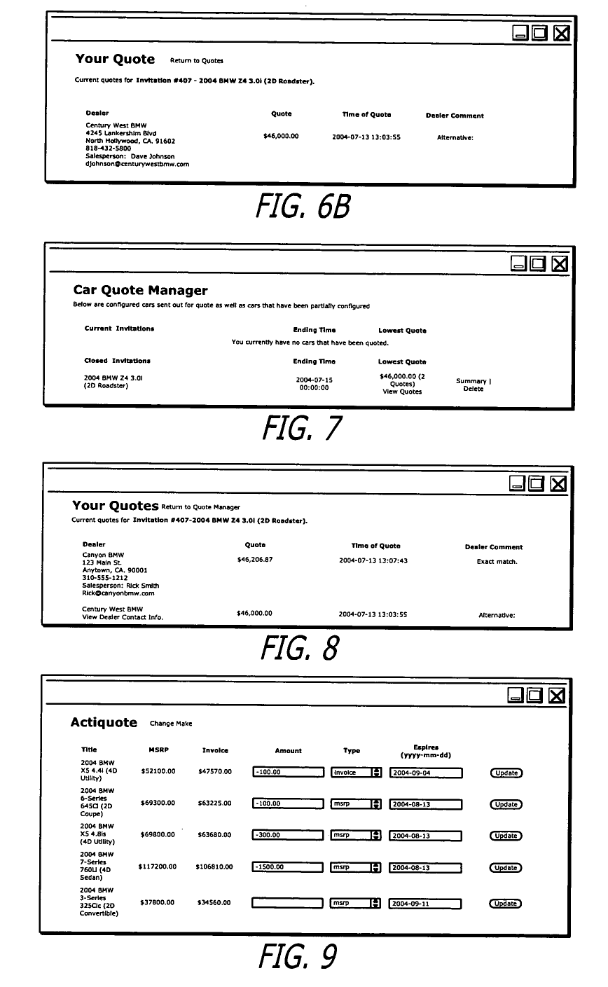

The system provides consumers with unique feedback mechanisms allowing them to keep apprised of the progress of the quotes. When the consumer has finished configuring his vehicle and submitting the request for a quote, the system sends to the consumer a message such as an email message stating, “Thank you for configuring a vehicle for competitive quote. Click here to monitor the progress of your quote. Please contact [email address] for any questions regarding this email or PriceGrabber Autos. You may also call us at [telephone number and extension].” The “Click here” anchor links to a page established by the system on the world wide web for that consumer to monitor the progress of that particular quote and possibly other quotes requested by the same consumer. Clicking on the link takes the consumer to the personalized quote progress page established on the system for that individual registered consumer. FIG. 6A is a simplified screen shot illustrating the main personalized quote progress page provided to the consumer to allow him to monitor the progress of the quote process while the quote period is open. The page displays the vehicle that is the subject of the current quote plus the lowest quote received, as well as any closed invitations. The consumer can choose to view the individual quotes received or a summary of the quotes received by clicking on respective links. FIG. 6B is a simplified screen shot illustrating some of the detail a consumer can view regarding a quote while the quote period is open.

Additionally, the user is sent a message such as an email message when a first quote or a subsequent quote is received, such as, “A new quote in the amount of $46,000 has just been entered on your configured vehicle. Click here to view the progress of your price quote” with a link to the consumer's quote progress page and again giving email and telephone numbers to contact if the consumer has a question.

The quote period remains open for a specified period of time such as three days. During that time dealers are sent messages advising them if their previously lowest quotes were beaten by another dealer. The dealer can then respond by submitting an updated quote that is lower than the currently lowest quote. If a lowest quote is sent within a specified minimum time of the quote period closing, such as one hour, the quote period may be extended in order to give other dealers the option of beating that new lowest quote.

Once the quote period has ended, the user is sent a message such as the following email message:
The period to submit quotes for your 2004 BMW Z4 3.0 liter convertible roadster has ended. Dave Johnson at Century West BMW in Hollywood has provided the lowest quote for this vehicle. Dave Johnson, Century West BMW, (310) 555-1212 (djohnson@centurywestbmw.com).
Please visit [link to consumer's quote progress page] to check the details of all final quotes you received. You may find that some dealers with higher quotes are providing better deals by adding more options or may be closer to you.
All quotes expire on 2004-08-12. Please contact the dealer you are interested in doing business with as soon as possible to buy this vehicle.
Dave Johnson Century West BMW has also been notified and may be contacting you.

FIG. 7 is a simplified screen shot illustrating the consumer's quote progress page after the quote period has closed. The user can choose to view individual quotes or a summary of the quotes.

In addition to sending the dealer's contact information to the user, the user's contact information as registered is automatically sent to the dealer who submitted the lowest exact quote. If the dealer attempts to contact the user using the user's contact information provided by the system but the dealer cannot effectively contact the user, the dealer can request within a specified period after the quote period closing time that the referral fee be canceled or refunded. If the system operator also cannot effectively contact the user, or in any other way determines that the dealer should not be charged for the referral, the referral fee may be canceled or refunded.

FIG. 8 is a simplified screen shot illustrating the options presented to the user to select one or more of the quotes other than the lowest exact match quote, and to receive contact information regarding those quotes. The user is presented with the contact information for the dealer submitting the lowest exact match quote. The user can also select or more of the other exact match quotes that were not of the lowest price, or one of the alternative quotes, i.e., one of the non-exact match quotes, to view the contact information for that second dealer. If the user elects to view the dealer contact information, the consumer's contact information is also sent to the second dealer and the second dealer is charged a referral fee. This second referral fee may also be canceled or refunded if the consumer cannot be contacted. Similarly, the consumer can select additional quotes for exchange of contact information, whereupon contact information is sent and the dealer submitting the selected quote is charged a referral fee.

FIG. 9 is a simplified screen shot illustrating the screen at which a dealer enters a standing quote or “Actiquote™.” The dealer can select particular vehicles with particular configurations, and for those vehicles specify what particular amount over or under dealer invoice or MSRP to quote, as well as the date at which the standing quote will expire, i.e., the date at which the system will cease submitting that automatic quote on the dealer's behalf. When an invitation to quote is received for which there is a corresponding standing quote entered by the dealer, the system can either respond by immediately submitting the standing quote, or can respond by submitting a quote that is just low enough to beat the otherwise lowest quote but is not the lowest amount specified within the standing quote order. In this way, the dealer's lowest possible quote will only be submitted if that is what is necessary to submit the lowest quote.

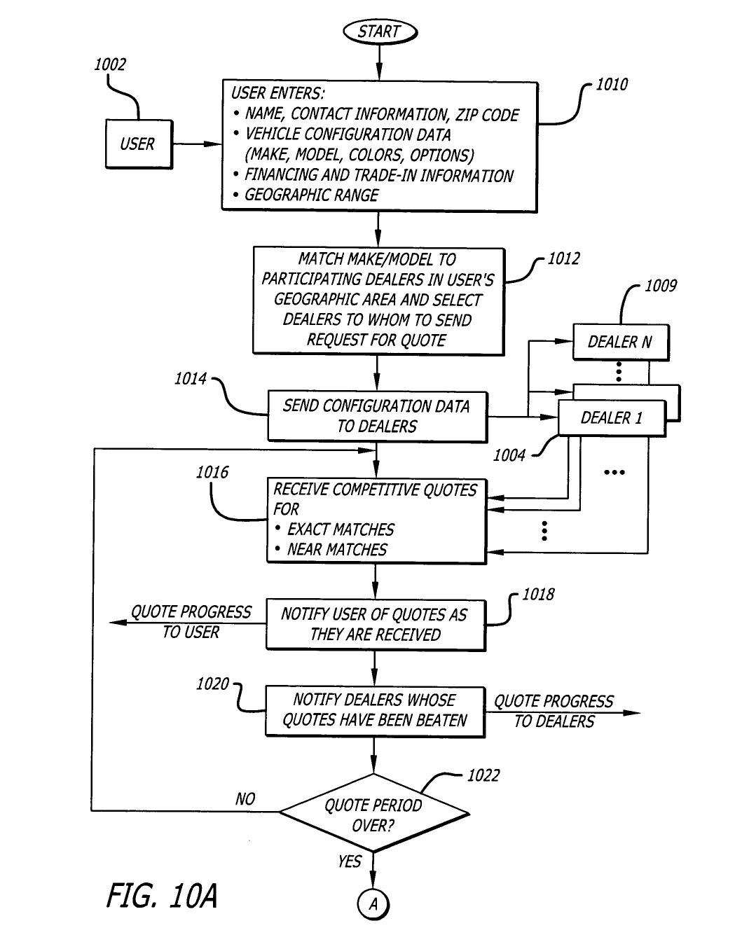

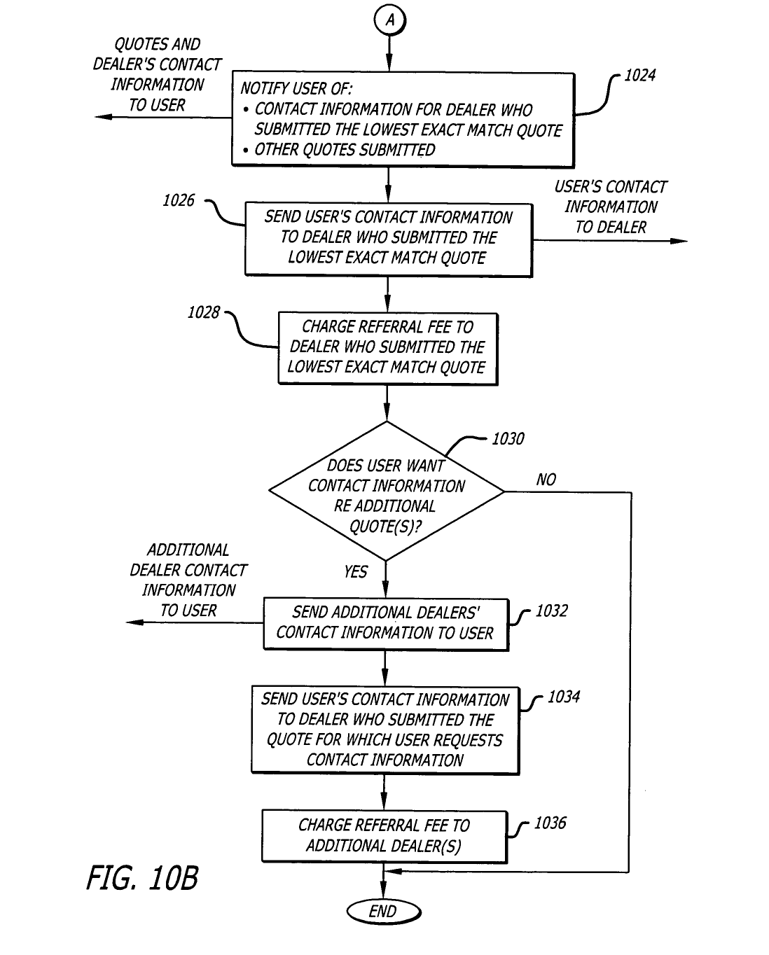

FIG. 10 is a generalized and simplified flow diagram generally illustrating the quote process. In the illustrative embodiment before the user can use the quote system the user must first become a registered user. The user becomes a registered user by providing his name, address, telephone number, email address, and possibly other identifying information such as driver's license number. A confirmation code is sent to the user at the user's email address. The user then enters that confirmation code at the system website to complete the registration process. Registering users is helpful to ensure that the system is used primarily by serious potential purchasers. The flow of the quote process will be explained with reference to both FIG. 10 and FIGS. 1-9.

User 1002 continues the quote process at 1010 by selecting an automobile, either by selecting the year, make, and model, or by specifying other parameters such as a vehicle type and a specified price range and then choosing from a pick list provided. See FIGS. 1 and 2. After choosing a vehicle the user configures the vehicle by choosing from various menus the exterior color, interior colors and fabrics, and other available options such as engine size, transmission type, interior trim, alloy wheels, power seats, heated seats, xenon headlights, keyless entry, sport suspension package, navigation package, two doors or four doors, and any other available options. See FIGS. 2A-2C. For color options, representative colors are provided on screen such that the colors displayed on the user's monitor or other screen match the automobile paint colors as nearly as possible. Various techniques are known for compensating for the monitor or other screen's color representations in order to match real world colors as closely as possible. The user can also optionally input trade-in information as in FIG. 2D, and the user's financing parameters as in FIG. 2E. This information generally constitutes the vehicle configuration data although the confirmation data need not include trade-in and financing information. The user also inputs his desired geographic range. See FIG. 3.

The system then matches at step 1012 the make and model of the car requested to dealers in the user's geographic area who sell that model automobile. After giving the user the opportunity to adjust the geographic data, the system then sends the configuration data to the participating dealers at step 1014, selected if necessary by the system from among the pool of possible dealers in order to prevent the request for quote from being sent to an unreasonably large number of dealers. The request for quote is sent to dealers shown generally as dealers 1004 through 1009. The dealers respond by submitting quotes. The quotes are received by the system at step 1016. The quotes typically include both exact matches and near matches.

The system notifies the user at step 1018 of quotes as they are received including the new lowest exact match quote when it is received. Users are also notified of non-exact match quotes along with a link so that the user can view the non-exact match quotes, thus stimulating consumer interest. Dealers are given an opportunity at step 1020 to beat the current lowest quote.

Once the quote period is over, at step 1024 the system sends to the user the contact information for the dealer who submitted the lowest quote, and also notifies the user of the other quotes received including both exact match quotes and non-exact match quotes. The system also notifies the user that the dealer submitting the lowest exact match may be contacting him soon. At step 1026 the system also sends to the dealer who submitted the lowest exact match quote the contact information from the user, and at 1028 charges the dealer a referral fee. The referral fee may be charged via a dealer's account kept on the system, electronic funds transfer, a charge to the dealer's credit card, or other well known methods of charging a fee. What the dealer receives in exchange for this fee is a referral to a registered consumer who has expressed a particularly high level of interest in the exact car in the exact configuration that the dealer is offering for sale, and has reason to believe that the dealer will give him the best possible deal on that automobile. The dealer is thus willing to pay the referral fee for this high value referral in addition to any periodic fee such as annual participation fee which may be charged to participating dealers.

Additionally, the user is given the option at step 1030 to view the details of other quotes submitted by other dealers, including both exact match quotes that may have been higher than the lowest quote but may be from dealers who are closer to the user and thus more desirable overall. The user can also view non-exact match quotes if those non-exact match quotes interest him. The non-exact match quotes may include, for example, a quote for a car with additional upgrade options not in the car as configured by the consumer, but nevertheless being offered at an attractive price by a dealer in an effort to move his existing inventory. The user is asked whether he wishes to have contact information exchanged with any of the dealers who submitted one or more of the other quotes. If the user clicks “yes” to exchange that contact information, then at step 1032 the contact information for the dealer on whose quote the user clicked is sent to the user, at step 1034 the user's contact information is sent to that second dealer, and at step 1036 that dealer is charged a referral fee. The referral fee charged to the second dealer may be more or less than the referral fee charged to the first dealer. The referral fee charged to the first dealer may also be reduced in response to the user selecting a second quote in order to compensate for the now-diluted value of the first referral, such that the first dealer is charged the highest fee level only when that dealer's exchange of contact information with the user is exclusive. Alternatively, the user could be charged a small fee for requesting contact information from a second or subsequent dealer in order to discourage indiscriminate selection of quotes which result in lower value referrals.

The quote and referral process is completed when the user chooses not to view additional information for any more quotes. The page at which the user elects to receive additional quote information is preferably left up and available to the user for at least a week after the quote period has closed, so that the user can elect to receive additional quote information if the user is unable or unwilling to purchase the vehicle from the first dealer. There may be many reasons which cause the user to not complete the purchase from the first dealer, including but not limited to the first dealer having sold the automobile from existing inventory before the user purchases it, the user not liking the first dealer's personal style, or the user perceiving a flaw in the particular vehicle offered.

It will be appreciated that the present invention is applicable for obtaining competitive quotes not only for motor vehicles such as automobiles, trucks, motorcycles, and recreational vehicles, but to other user- or purchaser-configured articles as well such as airplanes, boats, computers, stereo systems, other consumer electronics, and many other articles. Additionally, the invention may be used for competitive bidding for multiple articles such as an entire fleet of identical or different and differently configured vehicles. It will further be appreciated that although the invention is well suited to competitive bidding for user configurable articles, the articles need not necessarily be user configurable. For example, the present invention could be used to obtain bids on, and purchase, a specified commercial quantity of a standard product, or quantities of different products such as an entire purchase of office supplies or office furniture. The invention could also be used to purchase services. As one example, a homeowner could post photographs of the exterior of his or her house, provide any additional information that will be needed to obtain bids, and then painting contractors could bid for the job possibly without leaving their offices or requiring the homeowner to be present for a site inspection. As a second example, the invention could be used to obtain competitive bids for construction contracts and subcontracts with appropriate modifications of the user configuration process. Such modifications would include the uploading and display and/or emailing of files such as architectural drawings and specifications in the case of construction services. As a still further example, the invention could be used to obtain competitive quotes for machining molds and then producing specified quantities of injection molded parts, given specifications for the mold and the parts material. The possibilities are many.

Although the invention is well suited for implementation on the popular world wide web using its protocols and http links embedded within electronic mail messages, the invention could be implemented using other types of computer networks and software. Given the disclosure herein together with existing data regarding vehicles, their options, and their prices, someone of ordinary skill in the art of software programming could write the software code necessary to implement the invention. As part of the process of implementing the invention, the source and/or object code would be stored on at least one computer readable media for reading by a computer which would implement the process. The computer readable media would usually include at least a hard magnetic disc drive, but could include a CD ROM or other suitable media at one point or another within the programming, storing, loading, and implementing processes.

It will be appreciated that the term “present invention” as used herein should not be construed to mean that only a single invention having a single essential element or group of elements is presented. Similarly, it will also be appreciated that the term “present invention” encompasses a number of separate innovations which can each be considered separate inventions. Although the present invention has thus been described in detail with regard to the illustrative embodiment and illustrations thereof, it should be apparent to those skilled in the art that various adaptations and modifications of the present invention may be accomplished without departing from the spirit and the scope of the invention. For example, various modes of communication are available for configuring the desired article, inviting quotes from participating dealers, providing quotes, and notifying consumers and participating dealers of the progress of the quotes, and are generally suitable. Those methods include, but are not limited to, email, instant messaging, web pages, pagers, telephones, facsimile, and text messages via pagers and cellular telephones. The present invention could be adapted for use with any or even all of those communication methods, as well as communication modes that have yet to be invented or popularized. Still further, it will be understood that the term “article” as used in the claims which follow can refer either to a single discrete article or collectively to a set of separate and distinct articles, or to a service or services.

Accordingly, it is to be understood that the detailed description and the accompanying drawings as set forth hereinabove are not intended to limit the breadth of the present invention, which should be inferred only from the following claims and their appropriately construed legal equivalents.

We claim:

1. A method of providing to a user at least one offered price for an article comprising:
allowing the user to remotely enter configuration data to configure a desired article according to a preference of the user;
receiving the configuration data and forwarding the configuration data to a plurality of potential sellers of the article;
receiving selling bids representing offered selling prices from the potential sellers;
selecting at least one of the bids and forwarding the selected bid to the user;
charging a referral fee to the potential seller whose bid was forwarded to the user, the potential seller defining the selected seller.

2. The method of claim 1 further comprising:
closing receipt of bids at a specified time; and,
while said receipt of bids is still open, sending to the user an electronic message advising that a new lowest bid has been received.

3. The method of claim 1 further comprising:
providing to the user a personalized bid progress page on a global information network, the bid progress page displaying information regarding progress of selling bids received for the article as configured by the user.

4. The method of claim 1 wherein the plurality of potential sellers of the article to whom the configuration data is forwarded are selected based on their closeness to the user.

5. The method of claim 1 wherein the plurality of potential sellers of the article to whom the configuration data is forwarded are selected from a set of vendors using a selection method comprising a geographic filter and a random selection process.

6. The method of claim 1 further comprising sending contact information for the user to the selected seller and sending contact information for the selected seller to the user.

7. The method of claim 1 wherein:
the user receives information regarding the selected seller's bid;
the user receives information regarding the bid of at least a second potential seller; and
the contact information for the second potential seller is sent to the user after the user has sent a command requesting that information.

8. The method of claim 7 further comprising sending contact information for the user to the second potential seller and charging a second referral fee to the second potential seller.

9. The method of claim 1 wherein at least one of the bids represents a bid to sell to the user an article that is similar to but not identical to the article as configured by the user.

10. The method of claim 1 wherein the article is a motor vehicle and the potential sellers are new motor vehicle dealers.

11. The method of claim 1 wherein the article comprises a set of identically configured motor vehicles.

12. The method of claim 1 wherein the article comprises a set of different products in respective specified quantities.

13. The method of claim 1 wherein the article is an electronic device or system.

14. The method of claim 1 wherein at least one of the bids represents a standing bid by a potential seller.

15. The method of claim 14 wherein the standing bid is a bid that automatically expires after a specified period of time.

16. The method of claim 1 further comprising notifying the potential sellers of a currently lowest bid and allowing the potential sellers to submit updated bids in response thereto.

17. The method of claim 16 wherein the notifying step comprises sending an email message.

18. The method of claim 16 wherein the notifying step comprises sending a facsimile transmission.

19. The method of claim 1 further comprising canceling or refunding the referral fee if the user cannot be effectively contacted through user-provided contact information within a predefined period of time.

20. A computer programmed to implement the method of claim 1.

21. A computer-readable media containing instructions capable of causing a computer to implement the method of claim 1.

22. A method comprising:
receiving across a computer network configuration data for an article from a potential purchaser;
automatically sending the configuration data to a plurality of participating dealers of like articles;
receiving at least a first quote from a first one of said dealers, said first quote being for providing an article that exactly matches the configuration data provided by the potential purchaser;
receiving from a second one of said dealers:
at least a second quote, said second quote being for providing a near-match article that closely but not exactly matches the configuration data; and
data indicating a difference between the near-match article and the configuration data provided by the potential purchaser;
automatically selecting from among a plurality of exact match quotes received a lowest exact match quote and forwarding the exact match quote to the potential purchaser; and
automatically forwarding contact information to at least one of the potential purchaser and the dealer who submitted the lowest exact match quote.

23. The method of claim 22 further comprising:
charging a fee to the dealer who submitted the lowest exact match quote; and
not charging a fee to the potential purchaser.

24. The method of claim 22 further comprising:
allowing the potential purchaser to view the second quote corresponding to the near-match article;
providing to the potential purchaser the option to receive additional information regarding the second quote; and
if the potential purchaser elects to receive additional information regarding the second quote, then charging a fee to the dealer who submitted the second quote.

25. A method comprising:
receiving requests from a plurality of vendors to participate in a referral program;
receiving specification data from a potential purchaser;
selecting from the plurality of vendors a first subset of vendors based at least in part on the specification data, the first vendor subset including at least two members thereof;
communicating at least a portion of the specification data to the first vendor subset and receiving from the first vendor subset respective selling bids;
selecting from the received selling bids a first bid and forwarding the first bid to the potential purchaser;
communicating contact information for the potential purchaser to at least a first selected vendor whose selling bid was selected and forwarded to the potential purchaser; and
charging a fee to the first selected vendor.

26. The method of claim 25 wherein:
bids received initially from the first vendor subset define a first round of bids;
the method further comprises communicating at least one bid from the first round of bids to at least some members of the first vendor subset and receiving a second round of bids; and
the bid forwarded to the potential purchaser is a bid selected from the second round of bids.

27. The method of claim 26 further comprising:
extending a bid deadline if a lowest bid is received within a predetermined time of a scheduled bid deadline;
communicating the lowest bid to at least some of the vendors; and
allowing vendors to submit additional bids before the extended bid deadline.

28. The method of claim 25 further comprising:
allowing vendors to submit standing bids to be used when the specification data matches predefined standing bid criteria.

29. The method of claim 25 wherein said plurality of vendors are motor vehicle dealers, said specification data comprises configuration data for at least one motor vehicle, and the specification data is received over a global information network.

30. The method of claim 29 wherein the selling bids are transmitted by the vendors over a global information network.

31. A method comprising:
receiving electronically information regarding one or more articles from a potential purchaser;
sending electronically said information to a plurality of dealers of such articles;
receiving electronically offers from said dealers to sell articles at respective specified prices;
selecting at least one of said offers based on price, said selected offer having been submitted by a first dealer; and
forwarding contact information for the potential purchaser to the first dealer and charging a referral fee to the first dealer.

32. A method of facilitating competitive commerce comprising:
receiving an inquiry regarding a specified article from a potential purchaser thereof;
soliciting from sellers of like articles selling bids for said specified article and receiving selling bids in response thereto;
selecting a lowest bid from a bid pool, said bid pool comprising at least a subset of said received bids;
advising the potential buyer of the lowest bid and of the identity of the corresponding seller, said corresponding seller defining the bid winner;
providing a means for the bid winner to contact the potential buyer; and
charging a fee to the bid winner.

33. The method of claim 32 wherein said bid pool comprises only bids that are received from sellers who meet a geographic criterion relative to the potential purchaser.

34. The method of claim 33 wherein the potential purchaser specifies a maximum geographic distance.

35. The method of claim 32 wherein said receiving, soliciting, selecting, advising, and providing steps are performed automatically via at least one computer and a global information network.

36. In a system allowing a user to request a quote from a plurality of vendors for a user-configured article, the improvement comprising apprising the user electronically of progress of quotes received while a period for receiving said quotes remains open.

37. A method of soliciting and receiving competitive quotes for a user-configured article and communicating information about said quotes comprising:
allowing a consumer to configure an article using a browser program;
sending the configuration information to a plurality of vendors;
receiving respective quotes for the configured article from at least some of said vendors; and
while a quote period remains open for receiving additional quotes, apprising the user of progress of said quotes received.

38. The method of claim 37 wherein said apprising step comprises sending to the user an electronic mail message advising the user that a new lowest quote has been received.

39. The method of claim 37 wherein said apprising step comprises making available to the user a personalized quote progress page viewable by the user across a computer network using a browser program, said quote progress page allowing the consumer to view progress of quotes received.

40. The method of claim 39 wherein said personalized quote progress page includes a history of quotes received which, when those quotes were received, constituted the currently lowest quotes received for the article.

41. The method of claim 39 wherein said personalized quote progress page includes a history of all quotes received for the article.

42. The method of claim 40 wherein said personalized quote progress page includes quotes received for similar articles, said similar articles being configured similarly but not identically to the user-configured article, and information regarding how the similar articles for which quotes are provided differ from the user-configured article.

43. A system for facilitating competitive quotes for selling a shopper-configured article comprising:
means for allowing a shopper to specify a configuration of an article for possible purchase by the shopper;
means for electronically gathering a plurality of quotes for the article from a plurality of vendors;
means for automatically identifying one of said quotes as being a preferred quote;
means for forwarding the preferred quote to the shopper and specifically identifying the preferred quote as being preferred; and
means for allowing the vendor who submitted the preferred quote to contact the shopper.

44. The system of claim 43 further comprising means for charging the preferred vendor a fee unless the shopper cannot be effectively contacted using contact information provided by the shopper to the system.

45. The method of claim 43 further comprising means for allowing the shopper to monitor progress of quotes as new lowest quotes are received while a predefined period of time for receiving quotes is still open.

46. A system for gathering competitive quotes for a user-configured article and forwarding at least one of the quotes to a consumer, the system including a display page on a computer screen which allows a vendor to respond with a quote for an article that is configured similarly to but not exactly to the user-configured item, and to specify how the article offered by the vendor differs from the user-configured article.
